(19) United States
(12) Patent Application Publication
(10) Pub. No.: US 2017/0230712 A1
(43) Pub. Date: Aug. 10, 2017

(54) SYSTEM AND METHOD FOR CONTENT FILTERING

(71) Applicant: SONY CORPORATION, TOKYO (JP)

(72) Inventors: MARVIN DEMERCHANT, SAN DIEGO, CA (US); TANMAY AGNIHOTRI, SAN DIEGO, CA (US); HYEHOON YI, ESCONDIDO, CA (US)

(21) Appl. No.: 15/040,311

(22) Filed: Feb. 10, 2016

(51) Int. Cl. H04N 21/454; H04N 21/475; H04N 21/472; H04N 21/45

(52) U.S. Cl. CPC H04N 21/454; H04N 21/4532; H04N 21/4751; H04N 21/47217

(57) ABSTRACT

Various aspects of a system and a method to filter content are disclosed herein. In accordance with an embodiment, the system includes receipt of an input by a television (TV), which may enable selection of a viewing mode on the TV. A first set of content items is determined. The first set of content items is suitable for viewing by an age group associated with the selected viewing mode. A consolidated view may be generated. The consolidated view may include one or more selectable links to enable viewing of one or more of the determined first set of content items on the TV.

### CROSS-REFERENCE TO RELATED APPLICATIONS/INCORPORATION BY REFERENCE

None

### FIELD

Various embodiments of the disclosure relate to a system and a method to fitter content. More specifically, various embodiments of the disclosure relate to a system and a method to fitter content based on a viewer's age group.

### BACKGROUND

With technological advancements in the digital era, not only the number of electronic devices used in a household has increased, but the functionalities associated with such devices have also increased. Electronic devices have evolved as a source of entertainment and information. Nowadays, a Television (TV) may be used to not only view television programs but also access a range of online services, such as video-on-demand, social networking, and/or the Internet. Often, parents desire to control and manage content viewed on electronic devices by their children or other family members. However, due to the plethora of content items, such as games, apps, Internet videos, and TV shows available from various content sources, it may be difficult to ensure that only content considered appropriate to a viewers age be viewed on the electronic devices.

Further limitations and disadvantages of conventional and traditional approaches will become apparent to one of skill in the art, through comparison of described systems with some aspects of the present disclosure, as set forth to the remainder of the present application and with reference to the drawings.

### SUMMARY

A system and method to filter content us provided substantially as shown in, and/or described In connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates a network environment, in accordance with an embodiment of the disclosure.

FIG. 2 is a block diagram that illustrates various components of an exemplary electronic device, in accordance with an embodiment of the disclosure.

FIGS 3A to 3C, collectively, illustrate a first exemplary scenario for implementation of the disclosed system and method to filter content, in accordance with an embodiment of the disclosure.

FIG. 4 illustrates a second exemplary scenario for implementation of the disclosed system and method to filter content, in accordance with an embodiment of the disclosure.

FIG. 5A and 5B, collectively illustrate a first flow chart that illustrates an exemplary method to filter content in accordance with an embodiment of the disclosure.

FIG. 6 is a second flow chart that illustrates an exemplary method to filter content, in accordance with an embodiment of the disclosure.

### DETAILED DESCRIPTION

The following described implementations may be found to the disclosed system and method to fitter content. Exemplary aspects of the disclosure may include receipt of an input by a television (TV), which may enable selection of a viewing mode on the TV. A first set of content items may be determined as suitable for viewing by a particular age group associated with the selected viewing mode. A consolidated view may be generated. The consolidated view may include one or more selectable links that enable viewing of one or more of the determined first set of content items on the TV.

In accordance with an embodiment, the viewing mode may be a kid-safe mode, a family-safe mode, a teenager mode, an adult mode, and/or a user-defined mode. In accordance with an embodiment the first set of content items may be determined from among a plurality of content items available from one or more content sources. The plurality of content items available from the one or more content sources may correspond re spend to TV shows, TV channels, web content, video items from one or more Internet-based video streaming applications, video items from a pre-subscribed service, gaming applications, and/or other software applications.

In accordance with an embodiment, the first set of content items may be determined based on a pre-defined rating of a TV show or channel, a first user-setting to enable and/or disable one or more TV channels in the viewing mode, and/or a second user-setting associated with a viewing duration of the TV The first set of content items may be further determined based on a time of day a day or month of a year, a collective review information associated with one or more content items received from a server, and/or a historical usage pattern.

In accordance with an embodiment, a group of people of one or more age groups may be detected viewing the TV. The viewing mode may be switched to a family-safe mode based on the detection of the group of people. In accordance with an embodiment, a second set of content items may be determined. The second set of content items may be suitable tor viewing by the group of people of the one or more age groups associated with the family-safe viewing mode.

In accordance with an embodiment, an input may be received to select one of the one or more selectable links displayed at the TV. A content Item that corresponds to the selection may be retrieved from the first set of content items for playback at the TV. In accordance with an embodiment browsing of one or more content items from the plurality of content items available from one or more content sources at the TV, may be disabled. The one or more content items, tor which the browsing may be disabled, may be other than the determined first set of content items suitable tor viewing by the age group.

Another exemplary aspect of the disclosure may include an alternate system to filter content. In accordance with an embodiment, the alternate system may include a first electronic device that may be communicatively coupled to a second electronic device. An input may be received at the first electronic device to launch an application at the first electronic device. A first set of content items suitable for suitable for viewing by an age group associated with the launched application may be determined. A consolidated view may be generated. The generated consolidated view may include one or more selectable links that enable viewing of one or more of the determined first set of content terns from the first electronic device and/or the second electronic device.

In accordance with an embodiment the first electronic device may correspond to a smartphone, a tablet device, a wearable device, and/or other portable device. The second electronic device may correspond to a television (TV), and/or a display device. A first set of content items may be determined from among a plurality of content items available from one or more content sources associated with tie first electronic device and/or the second electronic device.

In accordance with an embodiment, a communicative coupling may be established with the second electronic device via a wireless communication protocol. In accordance with an embodiment an input may be received to select at least one of the one of more selectable Inks from the first electronic device. In accordance with an embodiment, a content item that corresponds to the selection may be retrieved from the first set of content items for payback at the first electronic device. In accordance with an embodiment, a content Hem that corresponds to the selection may be retrieved from the first set of content items for playback at the second electronic device.

In accordance with an embodiment, browsing of one or more content items other than the determined first set of content items, may be disabled. Browsing may be disabled tor the one or more content items available from one or more content sources at the first electronic device and/or the second electronic device.

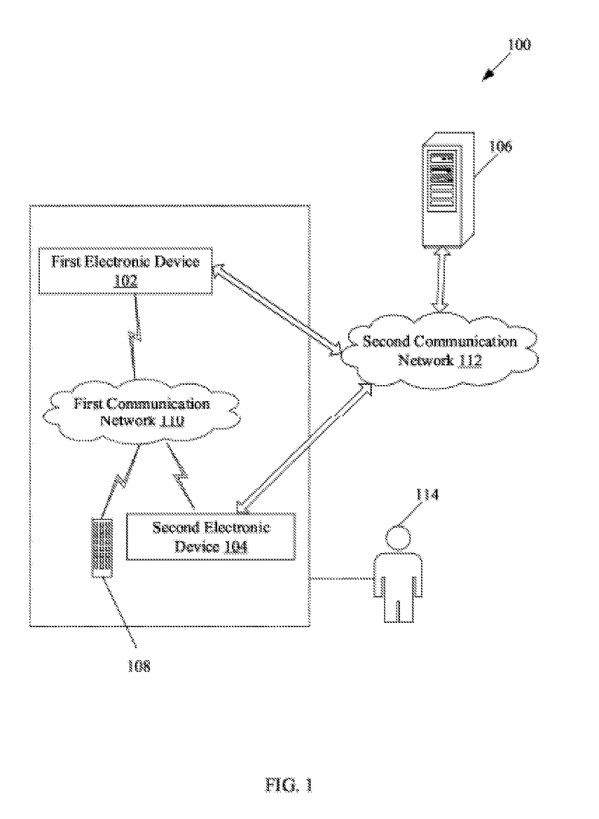

FIG. 1 is a block diagram that illustrates a network environment, in accordance with an embodiment of the disclosure. With reference to FIG. 1, there is shown an exemplary network environment 100. The network environment 100 may include one or more electronic devices, such as a first electronic device 102, a second electronic device 104, a server 106, a remote control 108, a first communication network 110, a second communication network 112, and one or mere users, such as a user 114. The user 114 may be associated with the remote control 108 and/or the one or more electronic devices.

The one or more electronic devices, such as the first electronic device 102 and the second electronic device 104, may communicate with each other via the first communication network 110. In accordance with an embodiment, the remote control 108 may communicate with the first electronic device 102 via the first communication network 110. The one or more electronic devices, such as the first electronic device 102 and the second electronic device 104, may be communicatively coupled with one or more servers, such as the server 106, via the second communication network 112.

The one or more electronic devices, such as the first electronic device 102 and the second electronic device 104, may be used to access one or more content items available from various content sources. Examples of the first electronic device 102 and the second electronic device 104 may correspond to, but are not limited to, a television (TV) (such as a digital TV or a smart TV), an Internet Protocol television (IPTV), a three-dimensional (3-D) TV, a tablet computer, a smart phone, a display device, and/or other electronic devices.

The server 106 may comprise suitable logic, circuitry, interfaces, and/or code that may be configured to receive a collective user review information from a plurality of electronic devices associated with a plurality of users. The collective user review information may be received via the second communication network 112. The collective user review information may refer to crowd-sourced data. The collective user review information may correspond to a user rating or a user review provided by the plurality of users, such as parents examples of the server 106 may include, but are not limited to, a database server, a web server, a file server, a media server, a communication server, and/or other servers.

The remote control 108 may refer to a TV remote control. The remote control 108 may comprise suitable logic, circuitry, interfaces, and/or code that may include a medium to control the first electronic device 102, such as a TV, via the first communicator network 110. In accordance with an embodiment, the remote control 108 may be a conventional remote control. In accordance with an embodiment, the remote control 108 may be a special-purpose remote control with a viewing mode button. The viewing mode button may be a hardware button that may enable selection of various viewing modes, such as a kid-safe mode or a family-safe mode. Examples of remote control 108 may include, but are not limited to, an infrared remote control, a radio frequency-based remote control, and/or a Light Fidelity (Li-Fi)-based remote control.

The first communication network 110 may include a medium through which the one or more electronic devices, such as the first electronic device 102 and the second electronic device 104, may communicate with each ether. The medium may be used by the remote control 108 to communicate with the first electronic device 102. Examples of the first communication network 110 may include, but are not limited to, a short-range communication network, a Wireless Fidelity (Wi-Fi) network, a Bluetooth (BT) Network, and/or a light-fidelity (Li-Fi) network. Various devices in the network environment 100 may be operable to connect to the first communication network 110, in accordance with various wired and wireless communication protocols. Examples of such wired and wireless communication protocols may include, but are not limited to, infrared (IR), IEEE 802.11, 802.16, IEEE 802.11s, IEEE 802.11g, Light Fidelity (Li-Fi), multi-hop communication, wireless access point (AP), a short-range device to device communication, cellular communication protocols, and/or Bluetooth (BT) communication protocols.

The second communication network 112 may include a medium through which the one or more electronic devices such as the first electronic device 102 and the second electronic device 104, may be communicatively coupled to the server 106. Examples of the second communication network 112 may include, but are not limited to, the internet a cloud network, a Local Area Network (LAN), a telephone line (POTS), wireless WAN and/or a Metropolitan Area Network (MAN). Various devices in the network environment 100 may be operable to connect to the second communication network 112, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, wireless mess network (WMN), IEEE 802.11, 802.16, IEEE 802.11s, IEEE 802.11g, Li-Fi, multi-hop communication, cellular communication protocols, and/or Long Term Evolution (LTE).

In accordance with an embodiment, the first electronic device 102 may be configured to access a plurality of content items from one or more content sources. The plurality of content items may correspond to the TV shows and/or TV channels. The plurality of content Items may further correspond to web content, social media, video items from one or more internet-based video streaming applications, and/or video items from a pre-subscribed service, such as a pre-subscribed satellite-based move-streaming service. The plurality of content terms may correspond to media or applications, such as gaming applications or other software applications pre-stored at the first electronic device 102 or online services accessed via the second communication network 112. In accordance with an embodiment the one or more content sources may include, but are not limited to, the internet, an input set-top box, or an external set-top box. The one or more content sources may be communicatively coupled with the first electronic device 102, a home network, and/or pre-stored data, such as audiovisual media or software applications.

In operation, the first electronic device 102, such as a TV, may be configured to receive an input that may enable selection of a viewing mode on the first electronic device 102. In accordance with an embodiment, the input may be a voice, a gesture, and/or a touch input. In accordance with an embodiment, the input may be a control signal, such as an infrared signal, received from the remote control 108. In accordance with an embedment, the viewing mode may be a kid-safe mode, a family-safe mode, a teenager mode, an adult mode, and/or a user-defined mode.

In accordance with an embodiment, the first electronic device 102 may be configured to determine a first set of content items suitable for viewing by an age group associated with the selected viewing mode. The first set of content items may be determined from among the plurality of content items available from the one or more content sources.

In accordance with an embodiment, the first set of content items may be determined based on a pre-defined TV rating of a TV show. The first set of content items may be determined based on a first user setting and/or a second user-setting, pre-configured by a user, such as the user 114. The user 114 may configure the first user-setting to enable and/or disable one or more TV channels for the viewing mode. The second user-setting may be associated with the viewing duration of the first electronic device 102, such as the TV viewing duration.

In accordance with an embodiment the first set of content items may be further determined based on a time of a day. For instance, the lime of receipt of an input to select the viewing mode, may indicate the time of day. The first set of content items may be determined based on a day or a month of a year. The day or month of the year may be derived from the timestamp when the input to select the viewing mode is received.

In accordance with an embodiment, the first set of content items may be determined based on a collective user review information associated with one or more content items received from the server 106. The collective user review information may be pre-stored at the server 106. In accordance with an embodiment, the first set of content items may be determined based on a historical usage pattern.

In accordance with an embodiment, the first electronic device 102 may be configured to generate a consolidated view. The consolidated view may include one or more selectable links that enable the viewing of one or more of the determined first set of content items on the first electronic device 102. The one or more selectable links may correspond to user interface (UI) elements, such as icons, of the various determined first set of content items. For example, a TV show icon, a TV channel icon, a game icon to launch a gaming application, and/or a movie streaming application icon. The UI elements selected to be appropriate for a certain age group associated with the selected viewing mode, may be included in the generated consolidated view. The first electronic device 102 may be configured to control display of the generated consolidated view an the first electronic device 102. The generated consolidated view may be displayed on a asp lay screen of the first electronic device 102, via the UI.

In accordance with an embodiment, the first electronic device 102 may be configured to receive an input to select at least one of the one or mote selectable links displayed on the UI of the first electronic device 102. The first electronic device 102 may be configured to retrieve a content item, which corresponds to the selected link, from the determined first set of the content items. The retrieved content item may be played on the first electronic device 102 in accordance with an embodiment, the first electronic device 102 may be configured to disable browsing of one or more content items other than the determined first set of content items, from the plurality of content items available from the one or more content sources at the first electronic device 102.

In accordance with an embodiment of the disclosure, the first electronic device 102 may be a touch-screen portable device, such as a tablet device, a smartphone, a wearable device, and/or other portable device. The second electronic device 104 may be a TV, or a display device. In accordance with an embodiment, the first electronic device 102 may be configured to establish a communicative coupling with the second electronic device 104 via a wireless communication protocol, such as a Wi-Fi, BT, Li-Fi communication protocols, of the first communication network 110.

In accordance with an embodiment, the first electronic device 102 may be configured to receive an input at the first electronic device 102, which may launch an application at the first electronic device 102. The application may be pre installed at the first electronic device 102. A similar application may also be pre-installed at the second electronic device 104, which may enable cross-talk between the two devices, such as the first electronic device 102 and the second electronic device 104.

In accordance with an embodiment, the first electronic device 102 may be configured to determine a first set of content items suitable tor viewing by an age group associated with the launched application. The first electronic device 102 may be configured to parse a plurality of content items available from the one or more content sources associated with the first electronic device 102, and/or the second electronic device 104. The first electronic device 102 may be configured to parse the plurality of content items by use of the application.

The plurality of content items may be the pre-stored gaming applications, movies, video items, or content items accessible via the second communication network 112 (such as the internet), via the first electronic device 102. The plurality of content items may further include the content items associated with the second electronic device 104, such as TV channels, TV shows, or other online services or pre-subscribed services, at the second electronic device 104. In accordance with an embodiment metadata associated with the plurality of content items at the first electronic device 102, and/or the second electronic device 104, maybe parsed in lieu of the plurality of content items.

In accordance with an embodiment, the first electronic device 102 may be configured to generate a consolidated view that may include one or more selectable links. The selection of the one or more selectable links may enable viewing of one or more of the determined first set of content items. In accordance with an embodiment, the first electronic device 102 may be configured to display the content item, such as a TV show, which corresponds to the selected link at the first electronic device 102. Alternatively, in accordance with an embodiment, the first electronic device 102 may be configured to communicate a control instruction to the second electronic device 104. The control instruction may include information associated with the selected link at the first electronic device 102. The second electronic device 104 may then play the content item, such as a TV show, which corresponds to the selected link at the first electronic device 102.

In accordance with an embodiment, the first electronic device 102 may be configured to disable browsing of one or more content items other than the determined first set of content items at the first electronic device or the second electronic device 104. In other words, the determined first set of content items that may be appropriate content items as per a viewer's age, such as a kid, may be browsed and/or viewed at the first electronic device 102 or the second electronic device 104.

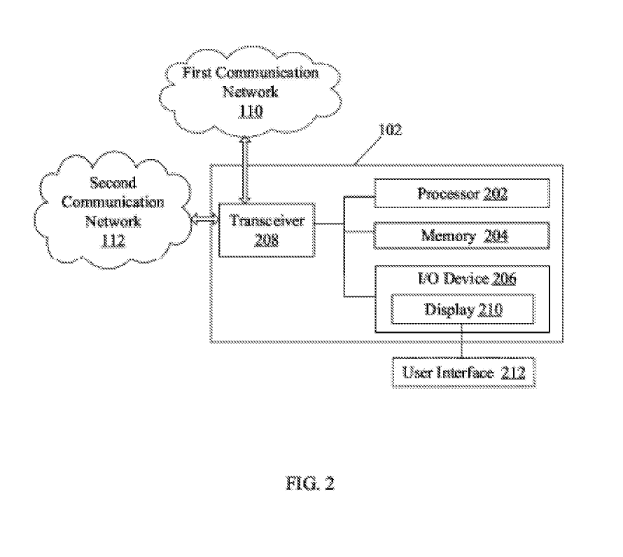

FIG. 2 is a block diagram that illustrates an exemplary electronic device, in accordance with an embodiment of the disclosure. FIG. 2 is described in conjunction with elements from FIG. 1. With reference to FIG. 2, there is shown the first electronic device 102. The first electronic device 102 may include one or more processors, such as a processor 202, a memory 204, one or more input/output (I/O) devices, such as an I/O device 206, a transceiver 208. The I/O device 206 may include a display 210. There is further shown the first communication network 110 and the second communication network 112 associated with the transceiver 208.

The processor 202 may be communicatively coupled to the memory 204. the I/O device 206, and the transceiver 208. The transceiver 208 may communicate with the second electronic device 104, via the first communication network 110, under the control of the processor 202. The transceiver 208 may further communicate with the server 106, via the second communication network 112, under the control of the processor 202.

The processor 202 may compose suitable logic, circuitry, interfaces, and/or code that may be operable to execute one or more instructions retrieved from the memory 204. Examples of the processor 202 may be an X86-based processor, a Reduced Instruction Set Computing (RISC) processor, an Application-Specific integrated Circuit (ASIC) processor, an Advanced RISC Machines (ARM) processor, a Complex Instruction Set Computing (CISC) processor, a central processing unit (CPU), and/or other processors or control circuits.

The memory 204 may comprise suitable logic circuitry, and/or interfaces that may be configured to store a set of instructions executable by the processor 202. The memory 204 may be further operable to store operating systems aid associated applications. Examples of implementation of the memory 204 may include, but are not limited to, Random Access Memory (RAM), Read Only Memory (ROM), Dynamic Random Access Memory (DRAM), Static Random Access Memory (SRAM), Electrically Erasable Programmable Read-Only Memory (EEPROM), Hard Disk Drive HDD), a Solid-State Drive (SSD), a CPU cache, a Secure Digital (SD) card, and/or a cache memory.

The I/O device 206 may compose suitable logic, circuitry, interfaces, and/or code that may be configured to receive an input from the user 114. The I/O device 206 may be further configured to provide an output to the user 114. The I/O device 206 may compose various input and output devices that may be operable to communicate with the processor 202. Examples of the input devices may include, but are not limited to, a camcorder, a touch screen, a keyboard, a mouse, a joystick, a microphone, a motion sensor, a light sensor, and/or a docking station. Examples of the output devices may include, but are not limited to, the display 210, a projector screen, and/or a speaker.

The transceiver 208 may comprise suitable logic, circuitry, interfaces, and/or code that may be configured to communicate with one or more other electronic devices, and the server 106, via the first communication network 110 and/or the second communication network 112. The transceiver 208 may include, but is not limited to, an antenna, a radio frequency (RF) transceiver, one or more amplifiers a tuner, one or more oscillators, a digital signal processor, a coder-decoder (CODEC) chipset, a subscriber identity module (SIM) card, and/or a local buffer. The transceiver 208 may communicate via wired or wireless communication with networks, such as the Internet an Intranet and/or a wireless network, such as a cellular telephone network, a wireless local area network (LAN) and/or a metropolitan area network (MAN). The wireless communication may use one or more communication standards, protocols and technologies, such as Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (IEEE 802.11a, IEEE 802.11b, IEEE 802 11g and/or IEEE 802.11n), voice over Internet Protocol (VoIP), Wi-MAX, a protocol for email, instant messaging, and/or Short Message Service.

The display 210 may comprise suitable logic, circuitry, interfaces, and/or code that may be configured to control display of the generated consolidated view on the first electronic device 102. In accordance with an embodiment the display 210 may be a touch-screen display. Example of the display 210 may include, but not limited to, a digital light processing (DLP) based display, a plasma display, a liquid crystal display (LCD), a thin film transistor (TFT) display, an electroluminescent display (ELD), a light emitting diode display (LED), and/or an organic light emitting diode (OLED) display.

The UI 212 may refer to an interface of an application pre instated in the memory 204. The UI 212 may be a graphical UI that may enable the user 114 to interact with the application, controls, and/or operating systems of the first electronic device 102. The UI 212 may be rendered on the display 210 of the first electronic device 102. The UI 212 may include one or more UI elements, such as graphical controls.

If an exemplary aspect of the disclosure, the first electronic device 102 may be a TV or a display device. In operator, the processor 202 may be configured to receive an input that may enable selection of a viewing mode on the UI 212, rendered on the display 210 of the first electronic device 102. In accordance with an embodiment the input may be a voice, a gesture, and/or a touch input in accordance with an embodiment, the input may be a control signal, such as an infrared signal, received from the remote control 108. In accordance with an embodiment, the viewing mode may be a kid-safe mode, a family-safe mode, a teenager mode, an adult mode, and/or a user-defined mode.

In accordance with an embodiment the processor 202 may be configured to determine a first set of content items suitable for viewing by an age group associated with the selected viewing mode. The first set of content items may be determined from among the plurality of content items available from the one or more content sources. For example, when the kid-safe mode is selected, certain content items that may be appropriate for a child to view may be determined from among the plurality of content items.

In accordance with an embodiment, the first set of content items may be determined based on a predefined TV rating of a TV show. For instance, the TV show may be a pre-evaluated content item or a TV program for which suitability may be reported for all age groups, such as children, teenagers, and/or adults, or a certain age group, such as adults. Accordingly, a rating may be associated with the content item, such as the TV show, in accordance with an embodiment, the first subset of the content items may be further determined on a pre-determined rating of a TV channel.

In accordance with an embodiment, the first set of content items may be determined based on a first user setting and/or a second user setting, pre-configured by a user, such as the user 114. The user 114 may configure the first user setting to enable and/or disable one or more TV channels for the viewing mode. The second user setting may be associated with the viewing duration of the first electronic device 102, such as the TV viewing duration. Certain category of content items, such as games, may have a pre-determined time limit for an age group. After the predetermined time, if the same category of content items, such as games, are played at the first electronic device 102, the processor 202 may automatically stop the content item to be played. Accordingly, the viewing duration may be controlled as per the age group associated with the viewing mode.

In accordance with an embodiment, the first set of content items may be further determined based on a time of a day. The time of a day may correspond to the time of recent of input to select the viewing mode. The first set of content items may be determined based on a day or a month of a year. The day or month of the year may be derived from the timestamp when the input is received to select the viewing mode.

In accordance with an embodiment, the first set of content items may be determined based on collective user review information associated with one or more content items received from the server 106. The collective user review information may be pre-stored at the server 106. For example, a group of parents may decode which content items may be appropriate for a child. In such a case, the parents may provide a rating or a review for the content item, via the first electronic device 102, the remote control 108, and/or the second electronic device 104. The review from each parent may be stored at the server 106. Such collective user-review information created by the group of parents may be utilized to determine that a certain content item is suitable for a child to view when the kid-safe mode is selected. Similarly, a group of users may provide ratings or reviews for a content item that may be suitable for a teenager, but may not be suitable for a child. Such collective user-review information from the group of users may be utilized to determine that a certain content item may be suitable for viewing by a teenager when the teenager mode is selected.

In accordance with an embodiment, the first set of content items may be determined based on a historical usage pattern. In accordance with an embodiment, the processor 202 may be configured to generate a favorite list of content items, based on the viewing, surfing, and recording habits of the user 114. The information related to historical usage pattern and/or the favorite content list may be stored in the memory 204. In accordance with an embodiment the viewing habits of a viewer, such as user 114, may include a duration and/or a frequency of viewing a content item or a category of content items, such as gaming, a TV channel, a TV show, a website, and the like. In accordance with an embodiment, the surfing habit of the user 114 may include navigation habits of an electronic program guide (EPG), navigation habits of a movie-streaming application via the Internet, or a temporal viewing pattern for certain content items. In accordance with an embodiment, the processor 202 may be further configured to identify a favorite content item of the user 114, based on the behavior associated with a usage history of selector of the content items via the UI 212.

In accordance with an embodiment, the processor 202 may be configured to generate a consolidated view. The consolidated view may include one or more selectable links to enable the viewing of one or more of the determined first set of content items on the first electronic device 102. The one or more selectable links may correspond to UI elements, such as icons, on the UI 212 of various determined first set of content items. For example, a TV show icon, a TV channel icon, a game icon to launch a gaming application, and/or a movie-streaming application icon mat may be appropriate for a certain age group, associated with the selected viewing mode, may be included in the generated consolidated view.

In accordance with an embodiment, the processor 202 may be configured to control display of the generated consolidated view on the display 210 of the first electronic device 102. The generated consolidated view may be shown on the display 210 of the first electronic device 102. via the UI 212.

In accordance with an embodiment the processor 202 may be configured to receive an input via the I/O device 206 to choose at least one of the one or more selectable links displayed on the UI 212 of the first electronic device 102. The processor 202 may be configured to retrieve a content item, which corresponds to the selected link, from the determined first set of the content items. The retrieved content item may be played on the first electronic device 102. In accordance with an embodiment, the processor 202 may be configured to disable browsers of one or more content items other than the determined first set of content items, from the plurality of content items available from the one or more content sources at the first electronic device 102.

In accordance with an embodiment, the processor 202 may be configured to detect a group of people of one or more age grows, such as a family, viewing the first electronic device 102. The processor 202 may be configured to switch the current viewing mode, such as the kid-safe mode, to a family-safe mode, based on the detection of the group of people. The processor 202 may be configured to determine a second set of content items. The second set of content items may be suitable for viewing by the group of people of the one or more age groups associated with the family-safe mode.

In accordance with an embodiment the second set of content items may be different from the first set of content items. In accordance with an embodiment some of the content items may be same while other content items may different between the first set of content items and the second set of content items. For example, certain content items, such as TV channels or movies, may be suitable to be viewed by various age groups, such as a child and an adult.

In accordance with an embodiment of the disclosure, the first electronic device 102 may be a touch-screen portable device, such as a tablet device, a smartphone, a wearable device, and/or other portable device. The second electronic device 104 may be a TV, or a display device. In accordance with an embodiment, the processor 202 may be configured to establish a communicative coupling with the second electronic device 104, by use of the transceiver 208. The communicative coupling may be established via a wireless communication protocol, such as a Wi-Fi, BT, Li-Fi communication protocols, of the first communication network 110.

In accordance with an embodiment, the processor 202 may be configured to receive an input at the first electronic device 102, to launch an application at the first electronic device 102. The UI 212 may be rendered on the display 210 of the first electronic device 102. The application may be pre-installed in the memory 204 of the first electronic device. 102 A similar application may also be pre-installed at the second electronic device 104, to enable cross-talk between the two devices, such as the first electronic device 102 and the second electronic device 104/

In accordance with an embodiment, the processor 202 may be configured to receive the first set of content items suitable for viewing by an age group associated with the launched application. For instance, the launched application may be a child-based application with pre-configured viewing mode, such as kid-safe mode. The processor 202 may be configured to parse a plurality of content items available from the one or more content sources associated with the first electronic device 102, and/or the second electronic device 104. The processor 202 may be configured to parse the plurality of content items by use of the application.

The plurality of content items may be the pre-stored gaming applications, movies, video items, or content items accessible via the second communication network 112, such as Internet, via the first electronic device 102. The plurality of content items may further include the content items associated with the second electronic device 104, such as TV channels, TV shows, or other online services or pre-subscribed services at the second electronic device 104. In accordance with an embodiment, metadata associated with the plurality of content items at the first electronic device 102 and/or the second electronic device 104, may be parsed instead of the plurality of content items itself.

In accordance with an embodiment, the parsing of plurality of content items may be a one-time activity. Once the plurality of the content items are parsed, the determination of the first set of content items may occur. In accordance with an embodiment, a table or list of content items with corresponding links to access or retrieve a content item from the first set of content items, may be generated. The table or list of content items may be consequently stored in the memory 204, the second electronic device 104, or the server 106. Such a database table or list may be periodically updated to include or remove one or more content items when such one or more content items become available from the one or more content sources. The update may be further based on a change in the rating of the one or more content items. Similarly, a change in the first user setting and/or the second user setting may also cause the update of the table or first of content items.

In accordance with an embodiment, the processor 202 may be configured to generate a consolidated view, which may include one or more selectable links. The selection of the one or more selectable links via the UI 212 may enable viewing of one or more of the determined first set of content items. In accordance with an embodiment, the processor 202 may be configured to display the content item, such as a TV show, which may correspond to the selected link at the first electronic device 102. Alternatively, in accordance with an embodiment, the processor 202 may be configured to communicate a control instruction to the second electronic device 104, via the transceiver 208. The control instruction may include information associated with the selected sink at the first electronic device 102. The second electronic device 104 may then play the content item, such as a TV show, which corresponds to the selected link at the first electronic device 102.

In accordance with an embodiment, the first electronic device 102 may be configured to disable browsing of one or more content items other man the determined first set of content items. Browsing may be disabled at the first electronic device or the second electronic device 104. In other words, the determined first set of content items that may be appropriate content items as per a viewer's age, such as a child, may only be browsed and/or viewed at the first electronic device 102 or the second electronic device 104. Content items inappropriate for that age group may not be viewable at the first electronic device 102 or the second electronic device 104. Thus, as described above, it may not be required to login or set up parental controls to restrict certain TV channels or shows. The disclosed system and method may provide a simple mechanism to find out and display the content that may be appreciate for an age group, such as a child.

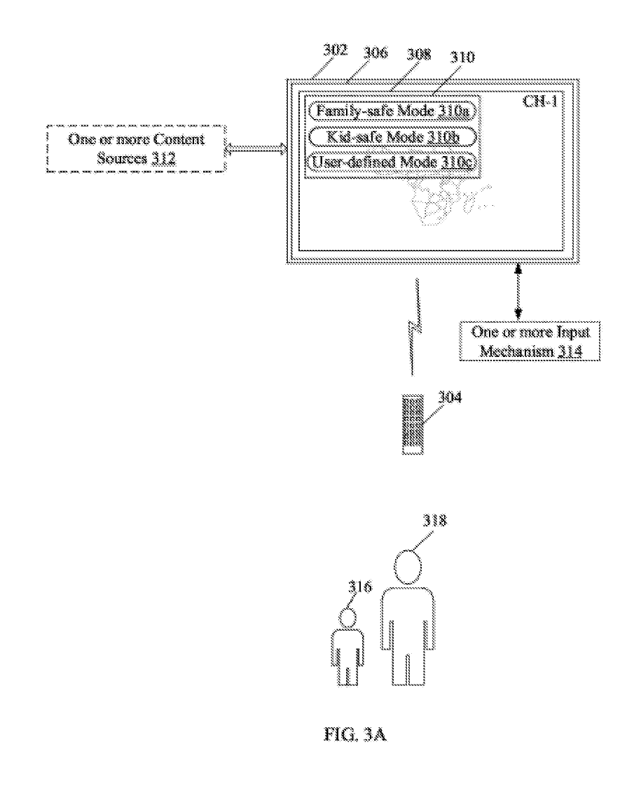

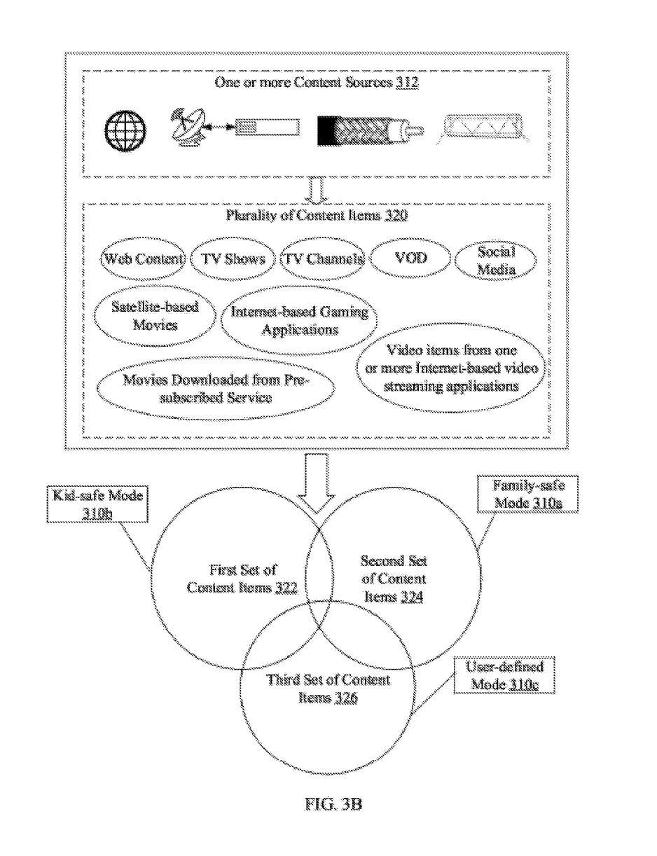

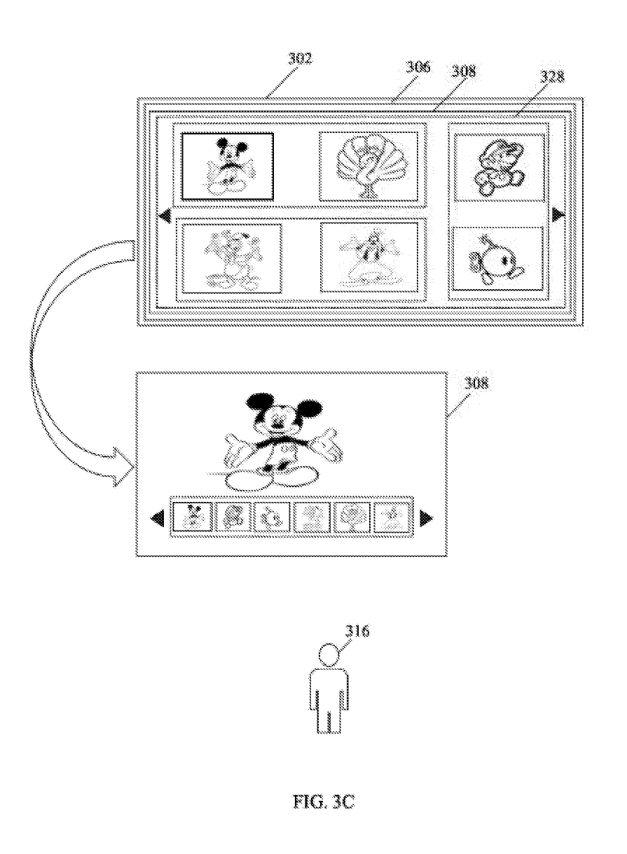

FIGS. 3A, 3B, and 3C, collectively, illustrate a first exemplary scenario for implementation of an exemplary system and method to filter content, in accordance with an embodiment of the disclosure. FIGS. 3A, 3B, and 3C are described in conjunction with elements of FIG. 1 and FIG. 2. With reference to FIG. 3A there is shown a television (TV) 302, a TV remote control 304, a TV display 306, a UI 308, one or more viewing modes 310, one or more content sources 312, one or more input mechanisms 314, a child user 316, and a parent user 318.

In accordance with the first exemplary scenario, the TV 302 may correspond to the first electronic device 102. The TV remote control 304 may correspond to the remote control 108. The TV display 306 may correspond to the display 210 The UI 308 may correspond to the UI 212 (FIG. 2). The one or more content sources 312 may include an in-built or an external set-top box connected to the TV 302. The one or more content sources 312 may further include one or more in-built or external storage devices, such as an external storage device, connected to the TV 302, which may enable access to pre-stored multimedia content items at the TV 302. The one or more content sources 312 may further include a coaxial cable and/or an optical finer cable, to access TV programs or other content items, social networks, or applications from the Internet. The in-built or external set-top box may be communicatively coupled to a satellite dish (not shown), to receive TV signals and/or other pre-subscribed services,

The one or more input mechanisms 314 may correspond to the I/O device 206. In accordance with an embodiment, the TV 302 may include the one or more input mechanisms 314, which receive input from alternative modes, such as voice based input or gesture input. The input may be received to enable browsing a plurality of content items available at the TV 302, from the one or more content sources 312. Further, the input may be received to enable navigation through an electronic program guide (EPG), and/or to operate various controls on the TV 302. The one or more input mechanisms 314 may also include a tablet device that may be communicatively coupled to the TV 302, via a wireless communication medium, such as the first communication network 110. The tablet device may act as a visual remote control to remotely operate the various controls, and browse through the EPG or the plurality of content items available at the TV 302.

In accordance with the first exemplary scenario, the child user 316 may want to view the TV 302. The TV 302 may be switched on by the parent user 318. The parent user 318 may want to ensure that the child user 316 views appropriate content on the TV 302. In operation, the parent user 318 may provide an input to select a viewing mode, such as the kid-safe mode 310b, on the TV 302. The Input may be provided via the TV remote control 304, or the one or more input mechanisms 314. The TV 302 may be configured to receive the input that may enable selection of the kid-safe mode 310b on the TV 302. In accordance with an embodiment, the selection of the kid-safe mode 310b may launch an application in the TV 302. The application may be a front-end application with a UI, such as the UI 308, a back-end application on the TV 302, and/or a back-end service associated with the server 106 (FIG. 1).

With reference to FIG. 3B mere is shown a plurality of content items 320, available from the one or more content sources 312, a first set of content items 322/ a second set of content items 324, and a third set of content items 326. The first set of content items 322 may be associated with the kid-safe mode 310b. The second set of content items may be associated with the family-safe mode 310a. Finally, the third set of content items 326 may be associated with the user-defined mode 310c.

The plurality of content items 320 may be similar to the plurality of content items as described in FIGS. 1 and 2. The plurality of content items 320 may include various TV shows, TV channels, video-on-demand (VOD) content items, movies that may be downloaded from a pre-subscribed service, web content, video items from one of more internet-based video streaming applications, internet gaming applications and/or social media.

In accordance with an embodiment, in response to the selection of the kid-safe mode 310b, the TV 302 may be configured to determine the first set of content items 322, suitable for viewing by the child user 316. The first set of content items 322 may be determined from among the plurality of content items 320 available from the one or more content sources 312. Similarly, in instances when other viewing modes of the one or more viewing modes 310 are selected, another set of content items suitable may be determined as per the selected mode.

For example, the TV 302 may be configured to determine the second set of content items 324, when the family-safe mode 310a is selected. The second set of content items 324 may be suitable for viewing by a family, such as the child user 316, the parent user 318, and/or other family members of different age groups. In accordance with an embodiment, the TV 302 may be configured to determine the third set of content items 326 when the user-defined mode 310c is selected.

With reference to FIG. 3C there is shown a consolidated view 328, rendered on the TV display 306 of the TV 302, via the UI 308. The consolidated view 328, may provide options to a viewer, such as the child user 316, to choose and view the selected content item from the determined set of content items, such as the first set of content items 322.

In accordance with an embodiment, the TV 302 may be configured to generate the consolidated view 328, based on the determined first set of content items 322. The generated consolidated view 328 may be displayed via the UI 308. The consolidated view 328 may include one or more selectable links that may enable viewing of one or more of the determined first set of content items 322. The determined first set of content items 322, which may be the appropriate content items for the age of the viewer, such as the child user 316, may only be browsed and/or viewed at the TV 302. Content items other than the first set of content items 322 may not be browsed and viewed at the TV 302. The consolidated view 328 may present one or more content items, such as icons with links to retrieve certain selective movies from internet-based movie streaming applications (such as “YouTube”), certain TV shows, and certain games, from the determined first set of content items 322. The determined first set of content items 322, which include the presented one or more content items, may be suitable for viewing by a child, such as the child user 316. Thus, only kid-safe content items, as determined by the TV 302, may be viewed on the TV 302. The selection of the kid-safe mode 310b and/or the launch of the application at the TV 302, may prevent display or browsing of inappropriate content items from the TV 302. The parent user 319 may then hand over the TV remote control 304 to the child user 316 without the risk of exposure of the child user 316 to content items inappropriate to the age of the child user 316.

In accordance with an embodiment, the TV 302 may be configured to receive an input to enable selection of the one or more content items, from the displayed consolidated view 328. The TV 302 may be configured to retrieve a corresponding content item from the determined first set of content items 322, for playback on the TV 302 via the UI 308. For instance, the child user 316 may select an icon from the consolidated view 328, to retrieve a “Mickey mouse” animation movie from an Internet-based movie streaming application, as shown. The parent user 318 may thus ensure that the child user 316 may not ne exposed to content items considered inappropriate as per the age of the child user 316.

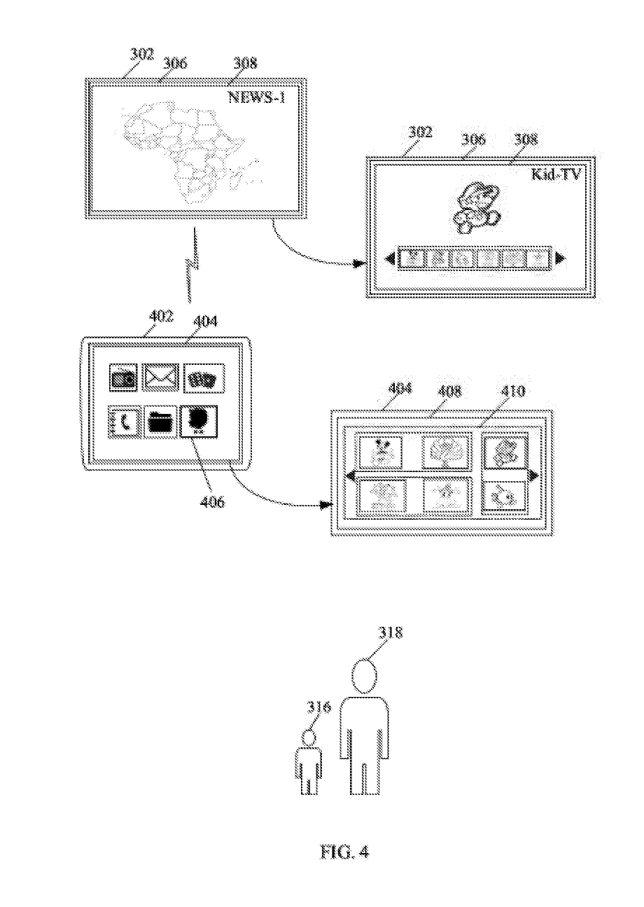

FIG. 4 illustrates a second exemplary scenario for implementation of the disclosed system and method to filter content, in accordance with an embodiment of the disclosure. FIG. 4 is described in conjunction with elements from FIGS. 1, 2, and 3A to 3C. With reference to FIG. 4, there is further shown a tablet device 402, a touch-screen display 404, an application interface 406 and a user interface (UI) 408 rendered on the touch-screen display 404 There is further shown a consolidated view 410 on the UI 408.

In accordance with the second exemplary scenario, the tablet device 402 may correspond to the first electronic device 102. The TV 302 may correspond to the second electronic device 104. The touch-screen display 404 may correspond to the display 210. The application interface 406 may be an interface used to launch a kid-safe application that corresponds to the application and UI 212 (described in FIG. 2). The UI 408 may be similar to that of the UI 212. The tablet device 402 may be communicatively coupled to the TV 302, via a wireless communication protocol, such as a Wi-Fi or BT communication protocol. The TV 302 may be switched on, and a TV channel, such as a “NEWS-1”, may be displayed on the TV 302. The parent user 318 may want to ensure that the child user 316 views appropriate content either on the TV 302 or on the tablet device 402.

In accordance with an embodiment, the parent user 318 may provide an input to launch an application, such as the kid-safe application, at the tablet device 402. The input may be provided to select the application interface 406 of the kid-safe application by use of the touch-screen display 404. The tablet device 402 may be configured to launch the kid-safe application at the tablet device 402, based on the received input. The kid-safe mode 310b may be pre-configured in the kid-safe application. The tablet device 402 may act as a visual remote control for the TV 302.

In accordance with an embodiment the tablet device 402 may be configured to determine a set of content items suitable for viewing by an age group associated with the launched kid-safe application. The set of content items may be determined from among the plurality of content items 320, available from one or more content sources 312 both at the TV 302 and at the tablet device 402. For example, the tablet device 402 may further include pre-stored gaming applications, movies, video items, or content items accessible via the second communication network 112, such as the Internet.

In accordance with an embodiment the tablet device 402 may be configured to generate the consolidated view 410, to enable viewing of one or more of the determined set of content items at the tablet device 402 or the TV 302. The consolidated view 410 may be a combined view and may include one or more selectable links to browse appropriate content item(s) from both the tablet device 402 and the TV 302.

In accordance with an embodiment the tablet device 402 may be configured to receive an input to enable selection of the one or more content items, from the displayed consolidated view 410 on the UI 408. The UI 408 may be a simple UI and easy to navigate for the child user 316. The tablet device 402 may be configured to customize fonts, color, and other visual appearance of the UI 408, suited for the child user 316 for easy navigation via the UI 408.

The tablet device 402 may be configured to retrieve a corresponding content item from the determined set of content items for playback on the TV 302 or the tablet device 402. For instance, the child user 316 may select an icon from the consolidated view 410 at the tablet device 402, to play a TV channel, such as “Kid-TV” on the TV 302. The tablet device 402 may be configured to disable browsing of one or more content items other than the determined set of content items at the tablet device 402 or the TV 302. Thus, it may be ensured that only certain content that may be considered appropriate for the age of the viewer, such as the child user 316, may be viewed on the TV 302 and/or the tablet device 402.

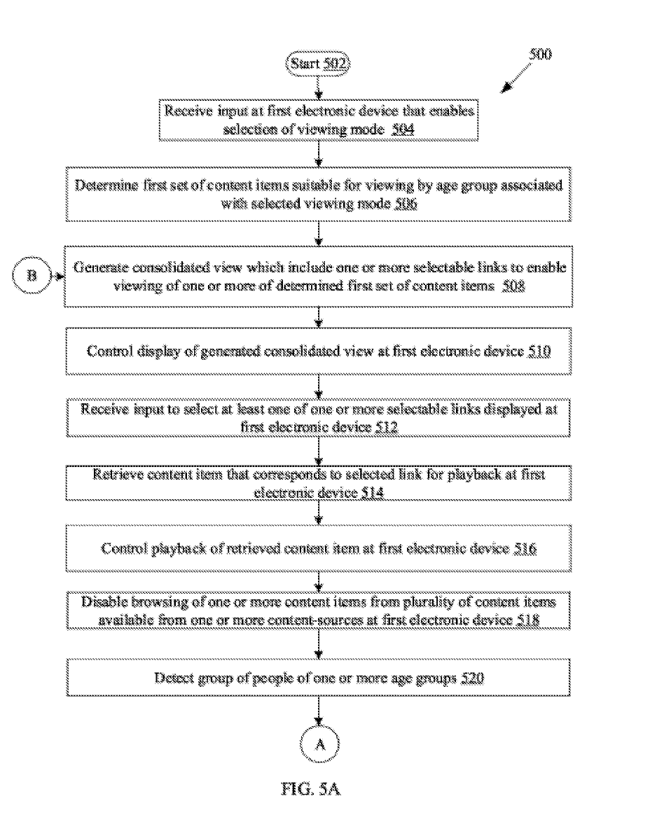

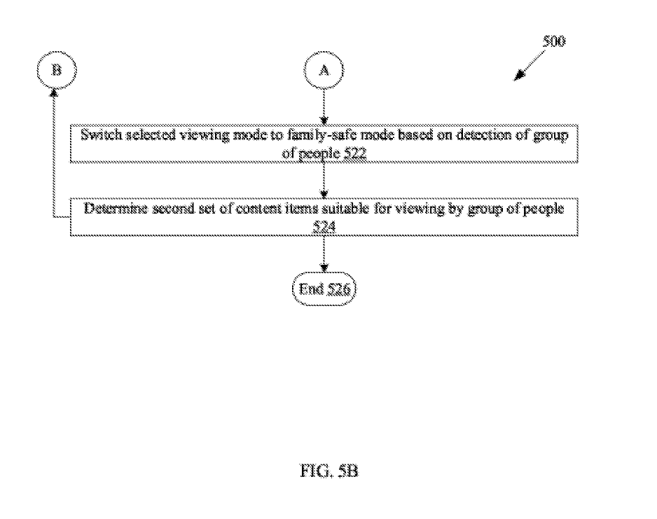

FIGS 5A and 5B, collectively, are a first flow chart that illustrates an exemplary method to filter content, in accordance with an embodiment of the disclosure. With reference to FIG. 5A and 5B, there is shown a flow chart 500. The flow chart 500 is described in conjunction with FIGS. 1, 2, 3A to 3C, and 4. The method starts at step 502 and proceeds to step 504.

At step 504, an input may be received by the first electronic device 102, such as the TV 302. The input may enable selection of a viewing mode, such as the one or more viewing modes 310, on the first electronic device 102. At step 506, a first set of content items suitable for viewing by an age group associated with the selected viewing mode, may be determined. An example of the first set of content items may be the first set of content items 322, as described in the FIG. 3B. The first set of content items may be determined from among the plurality of content items 320, available from one or more content sources 312.

At step 508, a consolidated view may be generated. The consolidated view may include at least one or more selectable links that enable viewing of the one or more of the determined set of content items, such as the determined first set of content items on the first electronic device 102 (such as the TV 302). An example of the consolidated view may be the consolidated view 328, as shown and described in FIG. 3C. At step 510, display of the generated consolidated view may be controlled at the fast electronic device 102. The generated consolidated view may be displayed via a UI, such as the UI 212 (FIG. 2), or the UI 308 (FIG. 3A and 3C).

At step 512, an input may be received to select at least one of the one or more selectable links displayed at the first electronic device 102 (such as the TV 302). At step 514, a content item that corresponds to the determined first set of content items may be retrieved for playback at the first electronic device 102.

At step 515, playback of the retrieved content item may be controlled at the first electronic device 102. The playback of the retrieved content item may be controlled based on a pre-defined setting associated with the selected viewing mode. For instance, in the kid-safe mode 310b, the visual appearance, search settings, fonts, color of UI, and/or other visual appearance may be changed and customized for a child, such as the child user 316. At step 518, browsing of one or more content items from the plurality of content items 320, available from the one or more content sources 312 at the first electronic device 102, may be disabled. The browsing of one or more content items other than the determined first set of content items suitable for viewing by the age group associated with the selected viewing mode, may be disabled at the first electronic device 102.

At step 520, a group of people of one or more age groups, such as family members, viewing the first electronic device, such as the TV 302, may be detected. The detection may occur by use of an image sensor, a microphone, and/or other sensors of the I/O device 206 (FIG. 2). At step 522, the selected viewing mode may be dynamically switched to the family-safe mode 310a, based on the detection of the group of people.

At step 524, a second set of content items suitable for viewing by the group of people of the one or more age groups may be determined. The determination of the second set of content items may be associated with the family-safe mode 310a. An example of the second set of content items may be the second set of content items 324 as described in the FIG. 3B. The second set of content items may be determined from among the plurality of content items 320, available from one or more content sources 312. The control may pass back to step 508 or end step 526.

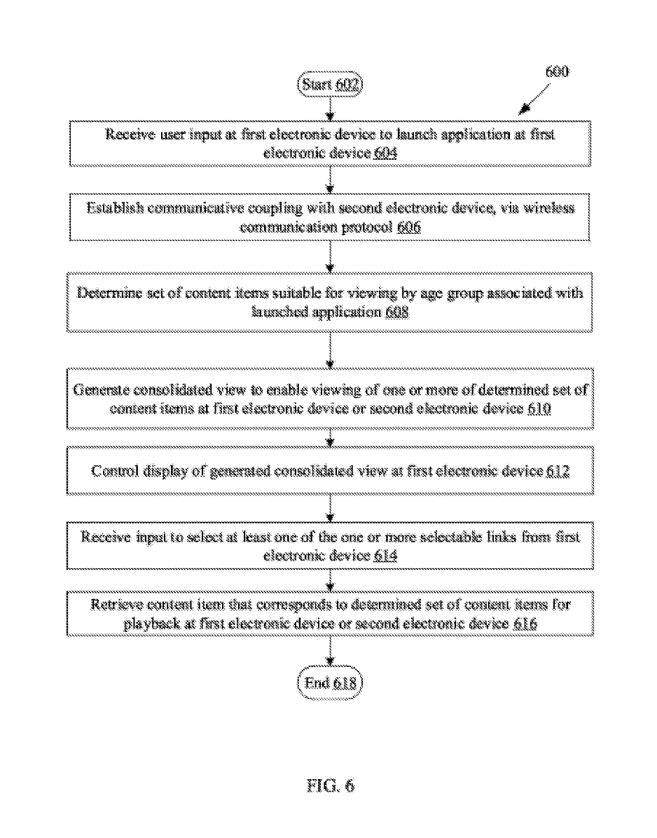

FIG. 6 is a second flow chart that illustrates an exemplary method to filter content, in accordance with an embodiment of the disclosure. With reference to FIG. 6, there is shown a flow chart 600. The flow chart 600 is described in conjunction with FIGS. 1, 2, 3A to 3C, and 4. The method starts at step 602 and proceeds to stop 604.

At step 604, an input may be received at the first electronic device 102, to launch an application at the first electronic device 102 (such as a tablet device 402). At step 606, a communicative coupling may be established with the second electronic device 104, via a wireless communication protocol. The communicative coupling may be established in response to the launched application at the first electronic device 102.

At step 608, a set of content items suitable tor viewing by an age group associated with the launched application, may be determined. Examples of the set of content items may correspond to the first set of content items 322, the second set of content items 324, or the third set of content items 326, as described in FIG. 3B. The set of content items may be determined from among a plurality of content items available from one or more content sources 312, associated with the first electronic device 102 and/or the second electronic device 104. At step 610, a consolidated view may be generated. The consolidated view may include one or more selectable links to enable viewing of one or more of the determined set of content items at the first electronic device 102, or the second electronic device 104. An example of the generated consolidated view may be the consolidated view 410, as shown and described in FIG. 4.

At step 612, display of the generated consolidated view may be controlled at the first electronic device 102, such as the tablet device 402. At step 614, an input may be received to select at least one of the one or more selectable links from the first electronic device 102. At step 616, a content item that corresponds to determined set of content items may be retrieved (or played back at the first electronic device 102 (such as the tablet device 402), of the second electronic device 104 (such as the TV 302). The control passes to end step 616.

In accordance with an embodiment of the disclosure, a system to filter content is disclosed. The system may include the first electronic device 102 (FIG. 1) which may comprise one or more circuits (hereinafter referred to as the processor 202 (FIG. 2)). The processor 202 may be configured to receive an input that may enable selection of a viewing mode on the first electronic device 102. The processor 202 may be configured to determine a first set of content items suitable for viewing by an age group associated with the selected viewing mode. The processor 202 may be further configured to generate a consolidated view which includes one or more selectable links to enable viewing of one or more of the determined first set of content items on the first electronic device 102.

In accordance with an exemplary aspect of the disclosure, another system to filter content is disclosed. The other system may include the first electronic device 102 (FIG. 1) that may be communicatively coupled to the second electronic device 104. The first electronic device 102 may comprise one or more circuits (hereinafter referred to as the processor 202 (FIG. 2)). The processor 202 may be configured to receive an input at the first electronic device 102 to launch an application at the first electronic device 102 (such as the tablet device 402). The processor 202 may be configured to determine a first set of content items suitable for viewing by an age group associated with the launched application The processor 202 may be further configured to generate a consolidated view that includes one or more selectable links to enable viewing of one or more of the determined first set of content items from the first electronic device 102 and/or the second electronic device 104.

Various embodiments of the disclosure may provide a non-transitory computer readable medium and/or storage medium, wherein there is stored thereon, a set of instructors executable by a machine and/or a computer to filter content. The set of instructions may cause the machine and/or computer to perform. The steps that comprise receipt of an input by the first electronic device 102 (such as the TV 302), which may enable selection of a viewing mode on the first electronic device 102. A first set of content items may be determined that may be suitable tor viewing by an age group associated with the selected viewing mode. A consolidated view may be generated. The consolidated view may include one or more selectable links to enable viewing of one or more of the determined first set of content items on the first electronic device 102.

Various embodiments of the disclosure may provide another non-transitory computer readable medium and/or storage medium, wherein there s stored thereon, a set of instructions executable by a machine and/or a computer to filter content. The set of instructions may cause the machine and/or computer to perform the steps that comprise receipt of an input at the first electronic device 102 to launch an application at the first electronic device 102. A first set of content items suitable for viewing by an age group associated with the launched application may be determined. A consolidated view may be generated. The generated consolidated view may include one or more selectable links to enable viewing of one or more of the determined first set of content items from the first electronic device 102 and/or the second electronic device 104.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departure from the scope of the present disclosure. In addition, many modifications may be made to adapt a particular situation or material to the teachings of the present disclosure without departure from its scope. Therefore, it is intended that the present disclosure not be limited to the particular embodiment disclosed, but that the present disclosure will induce all embodiments that fall within the scope of the appended claims.

What is claimed is:

1. A system for content filtering comprising:
one or more circuits in a television (TV) configured to:
receive an input that enables selection of a viewing mode on said TV;
determine a first set of content items suitable for viewing by an age group associated with said selected viewing mode; and
generate a consolidated view composing one or more selectable inks to enable viewing of one or more of said determined first set of content items on said TV.

2. The system according to claim 1, wherein said viewing mode is one of: a kid safe mode, a family-safe mode, a teenager mode, an adult mode, and/or a user-defined mode.

3. The system according to claim 1, wherein said first set of content items is determined from among a plurality of content items available from one or more content sources.

4. The system according to claim 3, wherein said plurality of content items available from said one or more content sources corresponds to one or more of: TV shows, TV channels, web content, video items from one or more Internet-based video streaming applications, video items from a pre-subscribed service, gaming applications of other software applications.

5. The system according to claim 1, wherein said first set of content items is determined based on one or more of: a pre defined rating of a TV show, a pre-defined rating of a TV channel, a first user-setting to enable and/or disable one or more TV channels in said viewing mode, a second user-setting associated with a viewing duration of said TV, a time of day, a day or month of a year, a collective user review information associated with one or more content items received from a server, and/or a historical usage pattern.

6. The system according to claim 1, wherein said one or more circuits are further configured to detect a group of people of one or more age groups viewing said TV, wherein said viewing mode is switched to a family-safe mode based on said detection of said group of people.

7. The system according to claim 6, wherein said one or more circuits are further configured to determine a second set of content items suitable for viewing by said group of people of said one or more age groups associated with said family-safe viewing mode.

8. The system according to claim 1, wherein said one or more circuits are further configured to receive an input to select at least one of said one or more selectable links displayed at said TV to retrieve a corresponding content item from said first set of content items for playback at said TV.

9. The system according to claim 1, wherein said one or more circuits are further configured to disable browsing of one or more content items from a plurality of content items available horn one or more content sources at said TV other than said determined first set of content items suitable for viewing by said age group.

10. A system for content filtering comprising:
one or more circuits in a first electronic device communicatively coupled to a second electronic device, said one or more circuits being configured to:
receive an input at said first electronic device to launch an application at said first electronic device;
determine a first set of content items suitable for viewing by an age group associated with said launched application; and
generate a consolidated view comprising at least one or more selectable links to enable viewing of one or more of said determined first set of content items from said first electronic device and/or said second electronic device.

11. The system according to claim 10, wherein said first electronic device corresponds to one of: a smartphone, a tablet device, a wearable device, and/or other portable device, wherein said second electronic device corresponds to one of: a television (TV), and/or a display device.

12. The system according to claim 10, wherein said first set of content items is determined from among a plurality of content items available from one or more content sources associated with said first electronic device and/or said second electronic device.

13. The system according to claim 10, wherein said one or more circuits are further configured to establish a communicative coupling with said second electronic device via a wireless communication protocol.

14. The system according to claim 10, wherein said one or more circuits are further configured to receive an input to select at least one of said one or more selectable links from said first electronic device to retrieve a corresponding content item from said first set of content items for playback at said first electronic device.

15. The system according to claim 10, wherein said one or more circuits are further configured to receive an input to select at least one of said one or more selectable links from said first electronic device to retrieve a corresponding content item from said first set of content items for playback at said second electronic device.

16. The system according to claim 10, wherein said one or more circuits are further configured to disable browsing of one or more content items, from a plurality of content items available from one or more content sources at said first electronic device and/or said second electronic device, other than said determined said first set of content items.

17. A method for content filtering composing:
receiving, by one or more circuits in a television (TV), an input that enables selection of a viewing mode on said TV;
determining, by said one or more circuits, a first set of content items suitable for viewing by an age group associated with said selected view mode; and
generating, by said one or more circuits, a consolidated view comprising one or more selectable links to enable viewing of one or more of said determined first set of content items on said TV.

18. The method according to claim 17, wherein said one or more circuits are further configured to detect a group of people of one or more age groups viewing said TV, wherein said viewing mode is switched to a family-safe view mode based on said detection of said group of people.

19. The method according to claim 18, wherein said one or more circuits are further configured to determine a second set of content items suitable for viewing by said group of people of said one or more age groups associated with said family-safe view mode.

20. The method according to claim 17, wherein sad one or more circuits are further configured to disable browsing of one or more content items from a plurality of content items available from one or more content sources at said TV other than said determined first set of content items suitable for viewing by said age group.
